(19) United States
(12) Patent Application Publication
(10) Pub. No.: US 2020/0030949 A1
(43) Pub. Date: Jan. 30, 2020

(54) METHOD AND DEVICE FOR SEPARATING A FASTENING ELEMENT FROM A FASTENING ELEMENT STRIP

(71) Applicant: HILTI AKTIENGESELLSCHAFT, Schaan (LI)

(72) Inventors: Thomas FOSER, Balzers (LI); Stefan ZIEGLER, Siebnen (CH)

(21) Appl. No.: 16/483,619

(22) PCT Filed: Feb. 19, 2018
(86) PCT No.: PCT/EP2018/053998

§ 371 Date: Aug. 5, 2019

(30) Foreign Application Priority Data
Feb. 23, 2017 (EP) 17157526.9

(51) Int. Cl. B25B 23/04; B25C 1/00

(52) U.S. Cl. CPC B25B 23/045; F16B 15/08; B25C 1/003

(57) ABSTRACT

A method and a device for separating a fastening element from a fastening element strip having a holder in which the fastening element is received, wherein the fastening element defines a fastening direction in which the fastening element is intended to be driven into a substructure, wherein the fastening element is transported in a transport direction until the fastening element is arranged in a separating portion, and a movement of the fastening element relative to the holder in a separating direction is generated until the fastening element is divided from the holder, and wherein the separating direction is inclined with respect to the fastening direction.

The invention relates to a method and a device for separating a fastening element from a fastening element strip with a holder in which the fastening strip is received.

Fastening elements, such as for example screws or nails, which are stored in a fastening element strip, are generally separated from the fastening element strip during the process of driving into a substructure. In the process, tilting moments potentially occur which adversely affect the driving process and thus also the quality of the fastening.

One object of the invention is to provide a method and a device by which a fastening element can be separated easily from a fastening element strip.

The object is achieved by a method for separating a fastening element from a fastening element strip with a holder in which the fastening element is received, wherein the fastening element defines a fastening direction in which the fastening element is to be driven into a substructure wherein the method includes transporting the fastening element in a transport direction until the fastening element is arranged in a separating portion, and the generation of a movement of the fastening elements relative to the holder in a separating direction until the fastening element is divided from the holder. The separating direction is thus tilted with respect to the fastening direction, preferably oriented perpendicularly to the fastening direction.

The object is also achieved by means of a method for separating a fastening element from a fastening element strip with a holder in which the fastening element is received, wherein the fastening element defines a fastening direction in which the fastening element is intended to be driven into a substructure, wherein the method includes transporting the fastening element in a transport direction until the fastening element is arranged in a separating portion and the generation of a movement of the fastening element relative to the holder in a separating direction until the fastening element is separated from the holder. A driving element is brought into engagement with the fastening element in order to drive the fastening element into the substructure after the fastening element is separated from the fastening element strip.

One advantageous embodiment is characterized in that the separating direction is tilted with respect to the transport direction, preferably oriented perpendicular to the transport direction.

One advantageous embodiment is characterized in that a separating element is moved with a movement direction in order to generate the movement of the fastening element relative to the holder. The movement direction is preferably tilted with respect to the fastening direction, particularly oriented perpendicular to the fastening direction. Likewise the movement direction is also preferably oriented parallel to the separating direction.

One advantageous embodiment is characterized in that the holder has an opening and in that a separating element is moved through the opening, in order to generate the movement of the fastening element relative to the holder.

One advantageous embodiment is characterized in that the holders are each provided with a slit which preferably extends along the fastening direction, and which is particularly preferably generally configured on the holder in the fastening direction. It is particularly preferable for the fastening element to be snapped out of the holder through the slit during the separating process.

One advantageous embodiment is characterized in that the holders are each provided with a predetermined breaking point, which preferably extends along the fastening direction. It is particularly preferable that the holder is broken at the predetermined breaking point during the separating process and the fastening element is moved out of the holder through the resulting breaking point.

The object is also achieved by means of a separating device for separating a fastening element from a fastening element strip with a holder, in which the fastening element is received, wherein the fastening element defines a fastening direction in which the fastening element is intended to be driven into a substructure, with a transport channel for transport of the fastening element strip in a transport direction, where the transport channel has a separating portion, and with a separating element, which has a standby position in which the separating element is arranged completely outside the transport channel, and a separating position in which the separating element protrudes into the separating portion, wherein a movement of the separating element from the standby position into the separating position is adapted to move a fastening element arranged in the separating portion relative to the holder in a separating direction, in order to disconnect the fastening element from the holder. The separating direction is therefore tilted with respect to the fastening direction, preferably oriented perpendicular to the fastening direction.

One advantageous embodiment is characterized in that the separating direction is tilted with respect to the transport direction, preferably oriented perpendicular to the transport direction.

Also advantageous is the separating direction in a storage attachment for a driving device used for driving fastening elements into a substructure, with an attachment which has a junction area for connecting the storage attachment with the driving device, and with a compression part, which has a contact area for the contact of the storage attachment on the substructure, wherein the attachment and the contact part are held, movable in a compression direction with respect to one another, along a displacement path, wherein the displacement path is bounded by a normal position and a compression position.

One advantageous embodiment is characterized in that the compression part has a holder for a fastening element, a passage for a drive element mounted on the driving device, by means of which a fastening element in the holder is driven into the substructure, and a supply channel connecting the separating portion and the holder together for supplying a separated fastening element in the separating portion to the holder.

One advantageous fastening system includes a driving device for driving fastening elements into a substructure, preferably a drill or a screwdriver, and a storage attachment as described, wherein the junction area is connected to the driving device.

The fastening element preferably includes a tip and/or a head. The fastening element is preferably provided with a thread and configured as a screw. In alternative embodiments, the fastening element is configured as a nail, bolt or the like.

Hereafter, preferred exemplary embodiments are explained more carefully with reference to the drawings. These show:

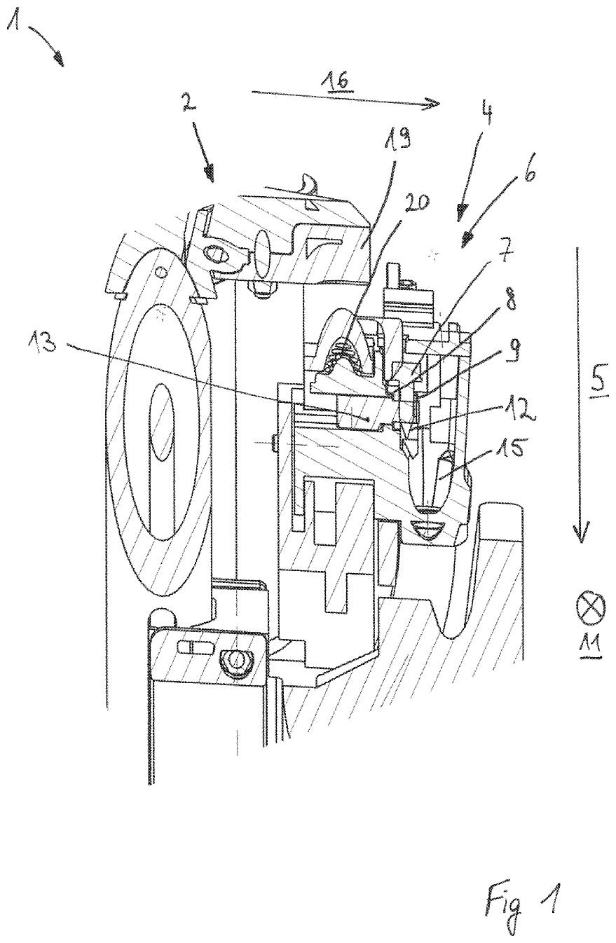

FIG. 1 a storage attachment with a separating device in a cross-section view,

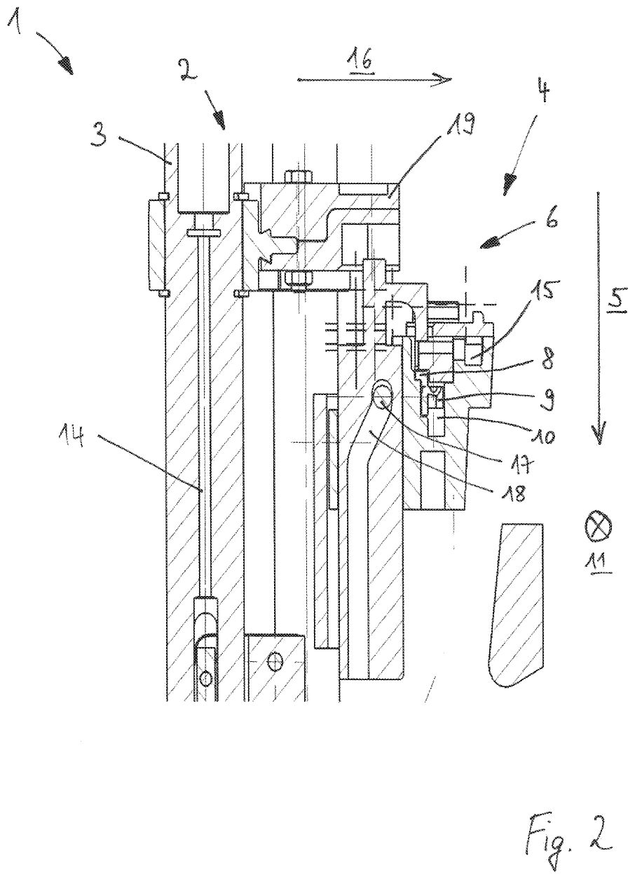

FIG. 2 the storage attachment with the separating device in another cross-section view, and

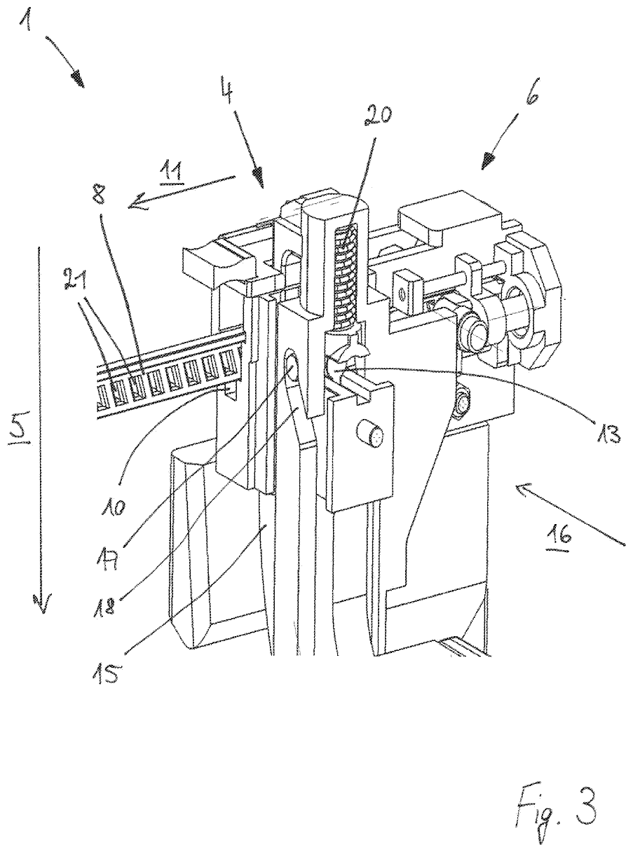

FIG. 3 the storage attachment with the separating device in an oblique view.

FIGS. 1, 2 and 3 show a storage attachment 1 for a driving device, not shown, for driving fastening elements into a substructure. The storage attachment 1 includes an attachment 2, which has a junction area 3 for connecting the storage attachment 1 with a driving device, such as a screwdriver for example, and a compression part 4, which has a contact area for contacting the storage attachment 1 to the substructure. The attachment and the compression part are held, movable with respect to one another in a compression direction 5 along a displacement path, wherein the displacement path is bounded by a normal position and a compression position.

The storage attachment 1 includes a separating device 6 for separating a fastening element 7 from a fastening element strip 8 with a holder 9 in which the fastening element 7 is held in such a manner that it defines a fastening direction which is identical with the compression direction 5 and in which the fastening element 7 is intended to be driven into a substructure. The separating device 6 includes a transport channel 10 for transport of the fastening element strip 8 in a transport direction 11. The transport channel 10 has a separating portion 12. Furthermore, the separating device 6 includes a separating element 13, which has a standby position, in which the separating element 13 is positioned completely outside the transport channel 10, and a separating position shown in FIGS. 1, 2 and 3, in which the separating element 13 protrudes into the separating portion 12.

The compression part 4 has a holder, not shown, for the fastening element 7, a passage 14 for a driving element mounted on the driving device, for example a screwdriver bit, by means of which the fastening element 7 in the holder can be driven into the substructure, and a supply channel 15 connecting the separating portion 12 and the holder to one another for supplying the fastening element 7 separated in the separating portion 12 to the holder.

For separation, the fastening element 7 is then transported in the transport direction 11 through the transport channel 10 to the separating portion 12. Pressing the storage attachment 1 against the substructure causes a displacement of the compression part 4 with respect to the attachment 2 in the compression direction 5. In the process, a control element 17 protruding from the separating element 13 runs in a control slot 18 of the compression part 4, thereby accomplishing a movement of the separating element 13 in a movement direction from the standby position into the separating position. The movement direction is oriented perpendicular to the fastening direction. The movement of the control slot 18 relative to the compression part 4 is brought about by an actuating element 19 mounted on the attachment 2 against the force of a return spring 20.

The movement of the separating element 13 leads to the movement of the fastening element 7 positioned in the separating portion 12 relative to the holder 9 in a separating direction 16, in order to divide the fastening element 7 from the holder 9. To this end, the separating element 13 is moved through an opening 21 on the fastening element strip 8. The separating direction 16 is thus oriented perpendicular to the compression direction 5, therefore also perpendicular to the fastening direction and parallel to the displacement direction of the separating element 13, thus also perpendicular to the transport direction 11. The separated fastening element 7 then falls due to gravity through the supply channel 15 configured for example as a downpipe to the holder, from which it is driven into the substructure.

The present invention was presented based on the example of a method and a device for separating a fastening element from a fastening element strip. It is also indicated, however that the method according to the invention and the device according to the invention can also be suitable to other application purposes.

1. A method for separating a fastening element from a fastening element strip having a holder in which the fastening element is received, wherein the fastening element defines a fastening direction in which the fastening element is intended to be driven into a substructure, wherein the method includes the following:
a) transporting the fastening element in a transport direction until the fastening element is positioned in a separating portion, and,
b) generating a movement of the fastening element relative to the holder in a separating direction, until the fastening element is divided from the holder, wherein the separating direction is tilted with respect to the fastening direction.

2. The method according to claim 1, wherein the separating direction is oriented perpendicular to the fastening direction.

3. The method according to claim 1, wherein the separating direction is tilted with respect to the transport direction.

4. The method according to claim 3, wherein the separating direction is oriented perpendicular to the transport direction.

5. The method according to claim 1, wherein the holder has an opening, and wherein a separating element is moved through the opening to generate movement of the fastening element relative to the holder.

6. The method according to claim 1, wherein the holder has a slit.

7. The method according to claim 6, wherein during b) the fastening element is snapped out of the holder through the slit.

8. The method according to claim 1 wherein the holder is provided with a predetermined breaking point.

9. The method according to claim 8, wherein during b) the holder is broken at the predetermined breaking point and the fastening element is moved out of the holder through the resulting predetermined breaking point.

10. A separating device for separating a fastening element from a fastening element strip having a holder in which the fastening element is received, wherein the fastening element defines a fastening direction, in which the fastening element is intended to be driven into a substructure, with a transport channel for transport of the fastening element strip in a transport direction, wherein the transport channel has a separating portion, and with a separating element which has a standby position, in which the separating element is positioned completely outside the transport channel, and a separating position in which the separating element protrudes into the separating portion, wherein a movement of the separating element from the standby position into the separating position is adapted to move a fastening element positioned in the separating portion relative to the holder in a separating direction, to divide the fastening element from the holder, wherein the separating direction is tilted with respect to the fastening direction.

11. The separating device according to claim 10, wherein the separating direction is oriented perpendicular to the fastening direction.

12. The separating device according to claim 10, wherein the separating direction is tilted with respect to the transport direction.

13. A storage attachment for a driving device for driving fastening elements into a substructure, comprising an attachment which has a junction area connecting the storage attachment with the driving device, and with a compression part which has a contact area for contacting the storage attachment to the substructure, wherein the attachment and the compression part are held movably with respect to one another in a compression direction along a displacement path, wherein the displacement path is limited by a normal position and a compression position, and wherein the storage attachment includes a separating device according to claim 10.

14. The storage attachment according to claim 11, wherein the compression part has a holder for a fastening element, a passage for a driving element mounted on the driving device, by which a fastening element in the holder is drivable into the substructure, and a supply channel connecting the separating portion and the holder together for supplying a fastening element separated in the separating portion to the holder.

15. A fastening system, including a driving device for driving fastening elements into a substructure, and a storage attachment according to claim 11, wherein the junction area is connected with the driving device.

16. The method according to claim 6, wherein the slit extends along the fastening direction and is configured on the holder in the fastening direction.

17. The method according to claim 8, wherein the predetermined breaking point extends along the fastening direction.

18. The method according to claim 2, wherein the separating direction is tilted with respect to the transport direction.

19. The method according to claim 2, wherein the holder has an opening, and wherein a separating element is moved through the opening to generate movement of the fastening element relative to the holder.

20. The method according to claim 3, wherein the holder has an opening, and wherein a separating element is moved through the opening to generate movement of the fastening element relative to the holder.
